(19) United States
(12) Patent Application Publication
(10) Pub. No.: US 2018/0356865 A1
(43) Pub. Date: Dec. 13, 2018

(54) DATA STORAGE DEVICE

(71) Applicant: INNODISK CORPORATION, New Taipei City (TW)

(72) Inventors: WEI-TING CHANG, NEW TAIPEI CITY (TW); CHENG-CHUN CHANG, NEW TAIPEI CITY (TW)

(21) Appl. No.: 15/854,196

(22) Filed: Dec. 26, 2017

(30) Foreign Application Priority Data
Jun. 12, 2017 (TW) 106119419

(51) Int. Cl. G06F 1/18; G06F 3/06; G06F 1/30; G06F 13/16; G06F 13/40; G06F 13/42; G06F 1/26

(52) U.S. Cl. CPC G06F 1/185; G06F 3/0679; G06F 1/30; G06F 13/1668; G06F 2213/0032; G06F 13/4068; G06F 13/4282; G06F 1/263; G06F 2003/0692; G06F 13/4095

(57) ABSTRACT

The presented invention provides a data storage device. The memory device comprises an interface card and an expansion board. The interface card comprises a controller, a transmission interface, a plurality of first data storage elements and a first connector. The expansion board comprises a plurality of second data storage elements and a second connector. The expansion board is connected to the first connector of the interface card by the second connector to be stacked on the interface card. The controller is able to access data of the first data storage elements and the second data storage elements. Thus, the data storage capacity of the data storage device can be expanded by the expansion board, having the data storage elements, configured on the interface card.

This non-provisional application claims priority claim under 35 U.S.C. § 119(a) on Taiwan Patent Application No. 106119419 filed Jun. 12, 2017, the entire contents of which are incorporated herein by reference.

### FIELD OF THE INVENTION

The present invention relates to a data storage device, more particularly, to a data storage device capable of extending functions.

### BACKGROUND

M.2 is a specification for multi-function expansion card and the new standard interface established by PCI-SIG and SATA-IO associations. M.2, originally known as the NGFF (Next Generation Form Factor), is now called M.2. M.2 interface can support transmit the signals of SATA, USB and PCIe, has a variety of dimensions and the advantage of fast transmission speed, and can be applied to various kinds of expansion cards like the solid state disk (SSD), WIFI, Bluetooth and near field communication (NFC), etc..

Currently, the M.2 interface card applied in SSD field is developed with various specifications like 22 mm (width)×30 mm (length), 22 mm×42 mm, 22 mm×60 mm, 22 mm×80 mm and 22 mm×110 mm. Furthermore, the dimension, especially the length of M.2 device usually affects its stored capacity. For example, the longer length of M.2 interface card (such as 22 mm×80 mm or 22 mm×110 mm) may be provided with a larger reserved space that is able to equip with more data storage elements (such as flash memories) to have a higher data storage capacity.

The current electronic product is designed towards the characteristics of light, thin, short and small. The ultra-slim compact electronic product is usually unable to provide enough space to accommodate the larger form factor of M.2 interface card, and therefore only select to use a small form factor of M.2 device in short length has a limited space that is unable to accommodate more data storage elements, so that the data storage capacity of the electronic product cannot be effectively improved.

For the reason, the present invention provides a novelty data storage device, in which the M.2 interface card of data storage device is able to further configure an expansion board thereon, in such a way that the smaller length of M.2 interface card may also have the higher data storage capacity, which is the object to be achieved by the present invention.

### SUMMARY

It is one object of the present invention to provide a data storage device, in which the data storage device comprises an interface card and an expansion board, the interface card and the expansion board comprise a plurality of data storage elements, respectively, the expansion board is stacked on the interface card by a connector. Thus, the data storage capacity of the data storage device may be expanded by configuring the expansion board on the interface card.

It is another object of the present invention to provide a data storage device, wherein the expansion board is provided with a plurality capacitors thereon. If the power outage occurs during the data storage device executing a data writing or backup, the capacitors are capable of discharging to provide an energy required by a short operation of the data storage device, so that the data storage device can complete to write or backup the important data into the storage elements.

It is another object of the present invention to provide a data storage device, wherein the expansion board is provided with at least one general purpose input and output (GPIO), at least one control command is able to be inputted into the data storage device via GPIO, the data storage device executes the data access operation according to the indication of the control command.

It is another object of the present invention to provide a data storage device, the expansion board is provided with a display unit for displaying the operating status and information of the data storage device.

To achieve the above objects, the present invention provides a data storage device, comprising: an interface card comprising a controller, a plurality of first data storage elements, a first connector, and a transmission interface, the controller being connected to the first data storage elements, the first connector, and the transmission interface; and an expansion board comprising a plurality of second data storage elements and a second connector, the second data storage elements being connected to the second connector, wherein the expansion board is connected to the first connector of the interface card by the second connector to be stacked on the interface card, the controller of the interface card is able to access data for the second data storage elements of the expansion board by the connection between the first connector and the second connector.

In one embodiment of the present invention, wherein the expansion board further comprises a plurality of capacitors, the capacitors are connected to the second connector, the expansion board provides a power energy to the interface card via the first connector and the second connector when the capacitors are discharged.

In one embodiment of the present invention, wherein the expansion board further comprises a general purpose input and output, at least one control command is inputted to the data storage device via the general purpose input and output, the controller of the interface card controls a data access operation between the interface card and the expansion board.

In one embodiment of the present invention, wherein the interface card comprises a detection tool, the detection tool is for detecting a operating status of the data storage device to generate at least one device operating status information.

In one embodiment of the present invention, wherein the expansion board further comprises a display unit connected to the second connector, the device operating status information will be transmitted to the expansion board via the first connector and the second connector, and displayed on the display unit of the expansion board.

In one embodiment of the present invention, wherein the device operating status information is health status of data storage elements, an information of operating temperature, an information of average erase count of data storage elements, an information of program erase count of data storage elements, or other information related to self-monitoring, analysis and reporting technology.

In one embodiment of the present invention, wherein the interface card is an interface card conforming to M.2 form factor standard interface.

In one embodiment of the present invention, wherein the interface card is an interface card conforming to mSATA form factor standard interface.

In one embodiment of the present invention, wherein the first connector and the second connector are a board to board connector or a connector for transmitting data signal, respectively.

In one embodiment of the present invention, wherein the data storage device further comprises at least one fixed part, the interface card and the expansion board are further provided with a plurality of holes, the fixed part passes through the holes of the interface card and the expansion board so as to fix the expansion board on the interface card.

### BRIEF DESCRIPTION OF THE DRAWINGS

FIG. 1 (a) and FIG. 1 (b) are a front structural view and a back structural view of an interface card according to one embodiment of the present invention.

FIG. 2 (a) and FIG. 2 (b) are a front structural view and a back structural view of an expansion board according to one embodiment of the present invention.

FIG. 3 is a cross-sectional structural view of the interface card combined with the expansion board each other according to one embodiment of a data storage device of the present invention.

FIG. 4 is a schematic view of a circuit block of the data storage device according to one embodiment of the present invention.

FIG. 5 is a front structural view of the expansion board according another embodiment of the present invention.

FIG. 6 is a schematic view of the circuit block of the data storage device according to another embodiment of the present invention.

FIG. 7 is a front structural view of the expansion board according another embodiment of the present invention.

FIG. 8 is a schematic view of the circuit block of the data storage device according to another embodiment of the present invention.

### DETAILED DESCRIPTION OF THE PREFERRED EMBODIMENTS

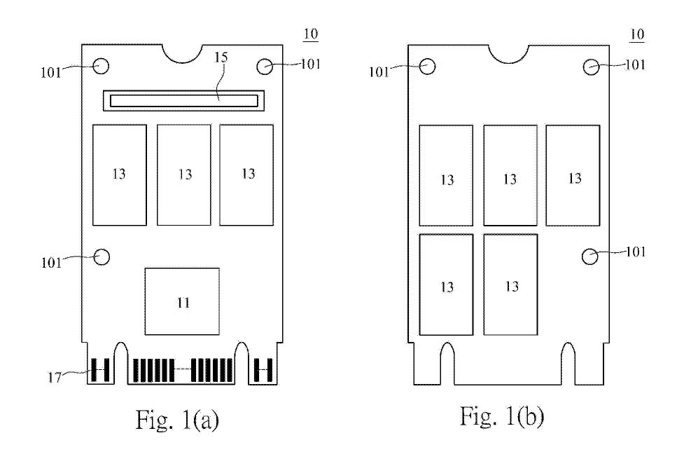

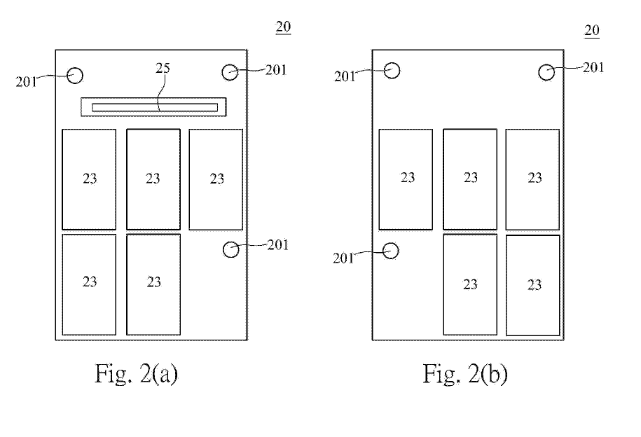

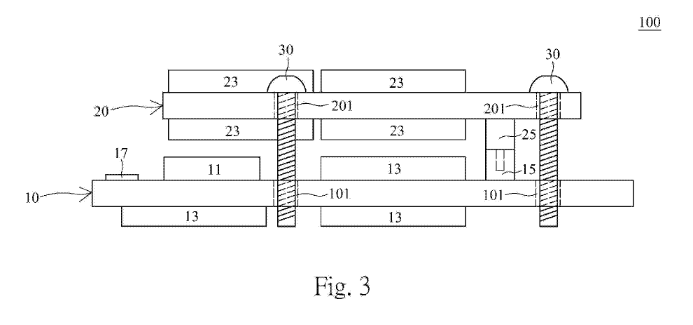

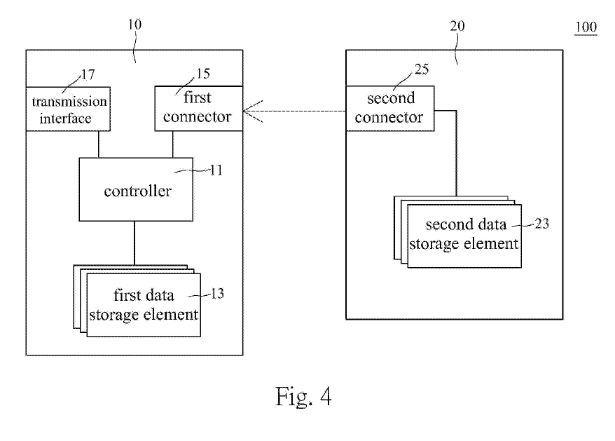

Referring to FIG. 1 (a) and FIG. 1 (b), there are shown a front structural view and a back structural view of an interface card according to one embodiment of the present invention, referring to FIG. 2 (a) and FIG. 2 (b), there are shown a front structural view and a back structural view of an expansion board according to one embodiment of the present invention, referring to FIG. 3, there is shown a cross-sectional structural view of the interface card connected to the expansion board each other according to one embodiment of a data storage device of the present invention, and referring to FIG. 4, there is shown a schematic view of a circuit block of the data storage device according to one embodiment of the present invention. As shown in those Figures, the data storage device 100 comprises an interface card 10 and an expansion board 20. The interface card 10 is an interface card conforming to M.2 form factor standard interface. The interface card 10 comprises a controller 11, a plurality of first data storage elements 13 (ex:flash memories), a first connector 15, and a transmission interface 17. The controller 11, the first connector 15, and the transmission interface 17 are selectively configured on a front of the interface card 10, and the first data storage elements 13 are selectively configured on the front and a back of the interface card 10. The controller 11 is connected to the first data storage elements 13, the first connector 15, and the transmission interface 17. The data storage device 100 of the present invention can be as a data storage medium of an electronic product when the transmission interface 17 of the interface card 10 is inserted into a connection seat of the electronic product.

The expansion board 20 comprises a plurality of second data storage elements 23 (ex:flash memory) and a second connector 25. The second connector 25 is selectively configured on a front of the expansion board 20, and the second data storage elements 23 are selectively configured on the front and/or a back of the expansion board 20. The second data storage elements 23 are connected to the second connector 25. In the present invention, the first data storage elements 13 and the second data storage elements 23 are flash memories, respectively, and the first connector 15 and the second connector 25 are a board to board (BTB) connector or a connector for transmitting data signal, for example, SATA, USB, PCIe, etc., respectively.

The expansion board 20 is connected to the first connector 15 of the interface card 10 by the second connector 25 to be stacked on the interface card 10. Afterwards, the controller 11 of the interface card 10 is able to access data for the second data storage elements 23 of the expansion board 20. Accordingly, the data storage device 100 can also improve the data storage capacity by the configuration of the expansion board 20 even if the data storage device 100 selects to adopt a small form factor M.2 device 10, for example, 22 mm×30 mm, 22 mm×42 mm, or 22 mm×60 mm, which are included, but not limited thereto.

In one embodiment of the present invention, the interface card 10 conforming to M.2 form factor standard interface is as an example of implementation. In other embodiment of the present invention, the interface card 10 may be an interface card conforming to mSATA form factor standard interface.

Furthermore, the bodies of the interface card 10 and the expansion board 20 are further drilled with a plurality of holes 101, 201. At least one fixed part 30, for example, screw member or a component with locking effect, can pass through the holes 101, 201 of the interface card 10 and the expansion board 20 so as to fix the expansion board 20 on the interface card 10.

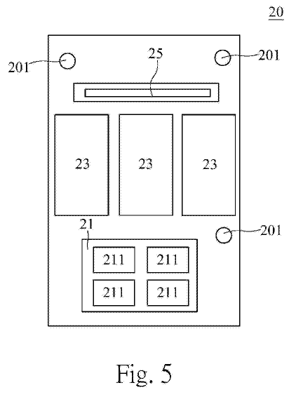

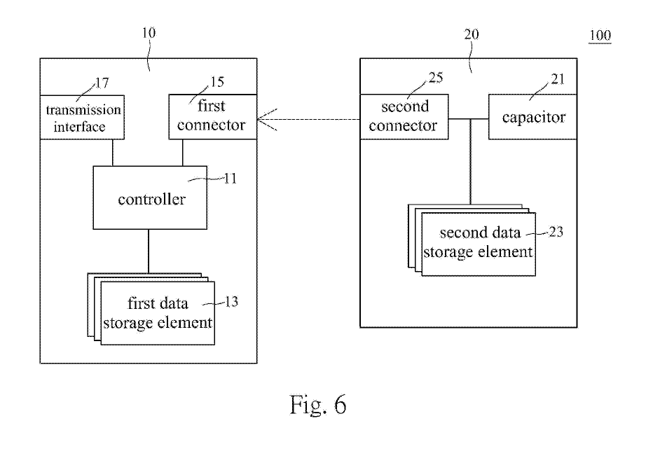

Referring to FIG. 5, there is shown a front structural view of the expansion board according another embodiment of the present invention, and referring to FIG. 6, there is shown a schematic view of the circuit block of the data storage device according to another embodiment of the present invention. As shown in FIG. 5 and FIG. 6, the expansion board 20 further comprises a plurality of capacitors 21. The capacitors 21 are consisted of a plurality of capacitor elements 211, for example, Tantalum capacitor elements, Electrolytic capacitor elements, MLCC capacitor elements, and so on. The capacitors 21 are connected to the second connector 25. When the capacitors 21 are discharged, it will generate a power energy and provide the power energy to the interface card 10 via the first connector 15 and the second connector 25. If the power outage occurs during the data storage device 100 executing a data writing or backup, the capacitors 21 are capable of discharging to provide the power energy required by a short operation of the data storage device 100, so that the controller 11 can complete to write or backup the important data into the first storage elements 13 and/or the second storage elements 23.

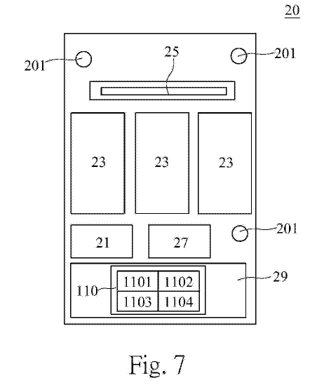

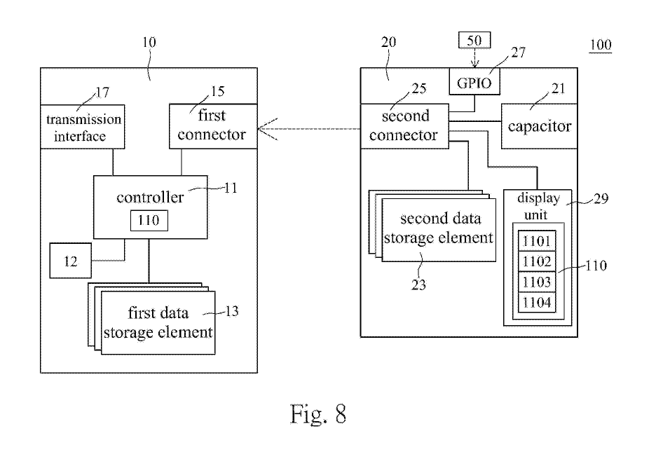

Referring to FIG. 7, there is shown the front structural view of the expansion board according another embodiment of the present invention, and referring to FIG. 8, there is shown the schematic view of the circuit block of the data storage device according to another embodiment of the present invention. As shown in FIG. 7 and FIG. 8, the expansion board 20 of the present embodiment further comprises one or more general purpose input and output (GPIO) 27 connected to the second controller 25. The data storage device 100 receives an external control command 50 via the GPIO 27 of the expansion board 20. The control command 50 is transmitted to the interface card 10 via the first connector 15 and the second connector 25. After the controller 11 of the interface card 10 receives the control command, it will control the data access operation of the interface card 10 and the expansion board 20 according to the indication or the requirement of the control command 50.

In one embodiment of the present invention, the control command 50 is an write protection command, the controller 11 can prohibit the user from executing the data written to the first storage elements 13 and the second storage elements 15 according to the requirement of the write protection of the control command 50. In other embodiment of the present invention, the control command 50 is an anti-deletion command, the controller 11 can prohibit the user from deleting the data stored in the first storage elements 13 and the second storage elements 15 according to the requirement of the anti-deletion of the control command 50. In another embodiment of the present invention, otherwise, the control command 50 is a data access authority command, the controller 11 can demand the user to input a verification code before the user desires to access or delete the data for the first data storage elements 13 and the second data storage elements 15 according to the indication of the data access authority of the control command 50. Besides, the above-described control commands 50 are merely part embodiments of the present invention, it will be understood by those skilled in the art that the data storage device 100 of the present invention, in accordance with the requirements for data access, data deletion, or data protection, may also be further developed a variety of different types of control commands 50, for example, security erase command, quick erase command, destroy command, and so on. Accordingly, there is the control commands 50 related to security data access, security data deletion or security data protection, all of which are claimed in the data storage device 100 of the present invention.

In the present embodiment, the interface card 10 further comprises a detection tool 12. The detection tool 12 is configured in the controller 11 or the first data storage elements 13 in a form of firmware or software. The controller 11 detects a operating status of the data storage device 100 to generate at least one device operating status information 110 by the use of the detection tool 12. For example, the usage status information 110 is an information of health status of data storage elements 13/23, an information of operating temperature, an information of average erase count of data storage elements 13/23, an information of program erase count of data storage elements 13/23, or other information related to self-monitoring, analysis and reporting technology. Afterwards, the device status information 110 will be transmitted to the expansion board 20 via the first connector 15 and the second connector 25, and displayed on a display unit 29, which is connected to the second controller 25, of the expansion board 20. The user can know the actual usage condition of the current data storage device 100 by the usage status information 110 displayed on the display unit 29 of the expansion board 20. In the embodiment of FIG. 6 or FIG. 8, the data storage device 100 can similarly select to adopt the M.2 interface card 10 of 22 mm×30 mm, 22 mm×42 mm, or 22 mm×60 mm, but not limited thereto.

Summed up the above description, the data storage capacity of the data storage device 100 of the present invention may be expanded by configuring the expansion board 20 on the interface card 10. And, the expansion board 20 may further provide additional functions, for example, the storing of charge, the inputting of control command, the displaying of the usage status, and so on, so that the data storage device 100 can perform the corresponding operations according to these additional functions.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

What is claimed is:

1. A data storage device, comprising:
an interface card comprising a controller, a plurality of first data storage elements, a first connector, and a transmission interface, the controller being connected to the first data storage elements, the first connector, and the transmission interface; and
an expansion board comprising a plurality of second data storage elements and a second connector, the second data storage elements being connected to the second connector, wherein the expansion board is connected to the first connector of the interface card by the second connector to be stacked on the interface card, the controller of the interface card is able to access data for the second data storage elements of the expansion board by the connection between the first connector and the second connector.

2. The data storage device according to claim 1, wherein the expansion board further comprises a plurality of capacitors, the capacitors are connected to the second second connector, the expansion board provides a power energy to the interface card via the first connector and the second connector when the capacitors are discharged.

3. The data storage device according to claim 1, wherein the expansion board further comprises a general purpose input and output, at least one control command is inputted to the data storage device via the general purpose input and output, the controller of the interface card controls a data access operation between the interface card and the expansion board.

4. The data storage device according to claim 1, wherein the interface card comprises a detection tool, the detection tool is for detecting a operating status of the data storage device to generate at least one device operating status information.

5. The data storage device according to claim 4, wherein the expansion board further comprises a display unit connected to the second connector, the device operating status information will be transmitted to the expansion board via the first connector and the second connector, and displayed on the display unit of the expansion board.

6. The data storage device according to claim 4, wherein the device operating status information is an information of health status of data storage elements, an information of operating temperature, an information of average erase count of data storage elements, an information of program erase count of data storage elements, or other information related to self-monitoring, analysis and reporting technology.

7. The data storage device according to claim 1, wherein the interface card is an interface card conforming to M.2 form factor standard interface.

8. The data storage device according to claim 1, wherein the interface card is an interface card conforming to mSATA form factor standard interface.

9. The data storage device according to claim 1, wherein the first connector and the second connector are a board to board connector, or a connector for transmitting data signal, respectively.

10. The data storage device according to claim 1, wherein the data storage device further comprises at least one fixed part, the interface card and the expansion board are further provided with a plurality of holes, the fixed part passes through the holes of the interface card and the expansion board so as to fix the expansion board on the interface card.
